(19) United States
(12) Patent Application Publication
(10) Pub. No.: US 2020/0265816 A1
(43) Pub. Date: Aug. 20, 2020

(54) VERTICAL GUITAR STAND

(71) Applicant: Carl Hancock, San Diego, CA (US)

(72) Inventor: Carl Hancock, San Diego, CA (US)

(21) Appl. No.: 16/796,846

(22) Filed: Feb. 20, 2020

Related U.S. Application Data
(60) Provisional application No. 62/808,071, filed on Feb. 20, 2019.

(51) Int. Cl. G10G 5/00

(52) U.S. Cl. CPC G10G 5/00

(57) ABSTRACT

Certain embodiments of the present application relate to a stand configured to hold a guitar vertically includes a front support and a rear support that are spaced apart to form the sides of a guitar body cavity having a width W and length L and height H. The width W may be fixed for one size guitar, or the width W may be variable to accommodate multiple guitars.

### RELATED APPLICATIONS

This application claims the benefit of U.S. Provisional Application No. 62/808,071 filed Feb. 20, 2019, which is incorporated herein by reference

### FIELD OF THE INVENTION

Embodiments of the present invention relate to a musical instrument support stand. In particular, some embodiments relate to a vertical guitar stand for standing a guitar in an upright position when not in use.

### BACKGROUND

Instruments such as guitars are subject to potential damage if simply laid flat on the floor, so it is common practice to lean the neck or head of the instrument against a piece of furniture or a wall. There are presently three variations of stands designed to hold a guitar in a roughly vertical plane. First is a tripod base (whether fixed of collapsible), second is a wall-mount which holds the guitar by the neck. Third is a square-based stand which also holds the guitar by the neck. Each of these have issues that the present invention overcomes.

The tripod base is a simple stand and serves as a platform to rest the guitar on. The guitar is placed loosely on the tripod base and many times the tripod base cannot sustain the musical instrument stably on the tripod. For movement of the guitar, the tripod base is carried separately, even if just moving the guitar around a room.

The wall-mount is a permanent holder that is attached in a particular location on a wall. It is not portable and cannot be moved with the guitar. In addition, attaching to the neck or head of the guitar has the potential for putting the instrument out of tune.

The square-based stand is typically a lightweight stand that holds the guitar by the neck to temporarily supporting the instrument when it is not being played. Similar to the wall mounted holder, attaching to the neck or head of the guitar has the potential for putting the instrument out of tune.

### SUMMARY

Accordingly, embodiments of the present invention have been made to overcome the problems associated with conventional stands. In accordance with various embodiments of the present invention, a guitar stand is provided that can be easily attached to a guitar and hold the guitar in a vertical position, while also be transported while attached to the guitar.

Certain embodiments of the present application relate to a stand configured to hold a guitar vertically includes a front support and a rear support that are spaced apart to form the sides of a guitar body cavity having a width W and length L and height H. The width W may be fixed for one size guitar, or the width W may be variable to accommodate multiple guitars.

Other features and aspects of the invention will become apparent from the following detailed description, taken in conjunction with the accompanying drawings, which illustrate, by way of example, the features in accordance with various embodiments of the invention.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIGS. 1A, 1B, 1C are top, front and side views showing one embodiment of a vertical guitar stand.

FIGS. 2A, 2B, 2C are top, front and side views showing another embodiment of a vertical guitar stand having feet.

FIGS. 3A and 3B are front and rear views showing one embodiment of an acoustic guitar positioned within a vertical guitar stand.

FIG. 4 is a top view showing one embodiment of a vertical guitar stand having a covering or fabric to protect the surfaces of the guitar against scratches.

FIG. 5 is a front view showing one embodiment of a vertical guitar stand having of an electric guitar positioned within.

FIG. 6 shows one embodiment of a vertical guitar stand having a foam with covering or fabric to protect the surfaces of the guitar against scratches.

FIGS. 7A, 7B, 7C are top, front and side views showing another embodiment of a vertical guitar stand.

FIG. 8 shows another embodiment of a vertical guitar stand having pedestal shaped supports.

It should be understood that the above exemplary Figures are not necessarily drawn to scale. Certain proportions thereof may be exaggerated, while others may be minimized. The figures are intended to illustrate various embodiments of the invention that can be understood and appropriately carried out by those of ordinary skill in the art.

### DETAILED DESCRIPTION OF THE DRAWINGS

Reference will now be made in detail to the present embodiments of the technology, examples of which are illustrated in the accompanying drawings. Similar reference numbers may be used to refer to similar components. However, the description is not intended to limit the present disclosure to particular embodiments, and it should be construed as including various modifications, equivalents, and/or alternatives of the embodiments described herein.

It will be understood that the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) when used herein, specify the presence of stated features, integers, steps, operations, elements, and/or components, but do not preclude the presence or addition of one or more other features, integers, steps, operations, elements, components, and/or groups thereof.

It will be further understood that, although the terms first, second, third etc. may be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

It will be further understood that when an element is referred to as being “on”, “attached”, “connected” or “coupled” to another element, it can be directly on or above, or connected or coupled to, the other element, or one or more intervening elements can be present. In contrast, when an element is referred to as being “directly on”, “directly attached”, “directly connected” or “directly coupled” to another element, there are no intervening elements present. Other words used to describe the relationship between elements should be interpreted in a like fashion (e.g. “between” versus “directly between,” “adjacent” versus “directly adjacent,” etc.).

The term “and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

The expression “configured (or set) to” used in the present disclosure may be used interchangeably with, for example, the expressions “suitable for”, “having the capacity to”, “designed to”, “adapted to”, “made to” and “capable of” according to a situation. The expression “configured (or set) to” does not mean only “specifically designed to” in hardware. Alternatively, in some situations, the expression “a device configured to” may mean that the device “can” operate together with another device or component.

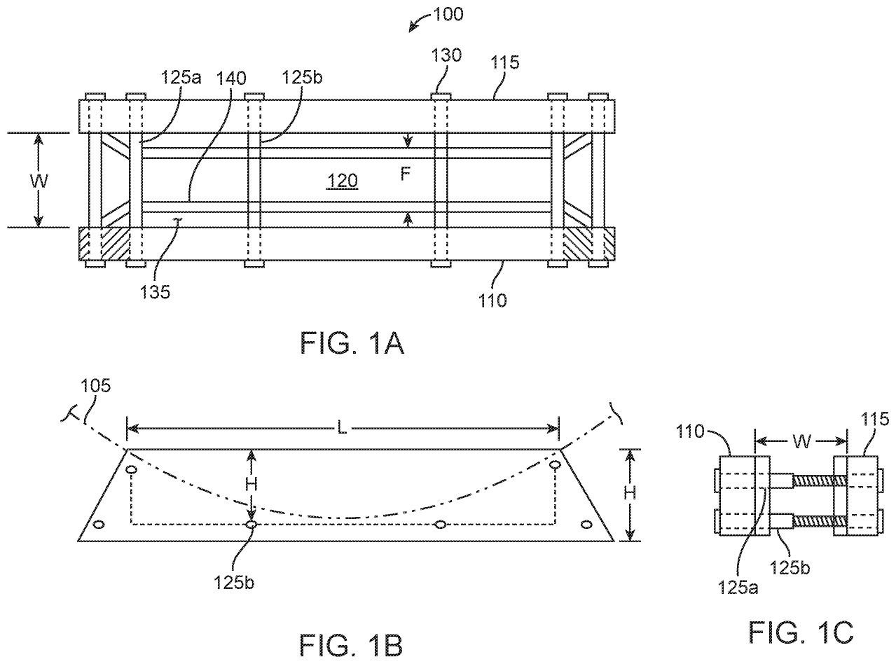

FIGS. 1A, 1B and 1C show one embodiment of a vertical guitar stand 100 that is designed to hold a guitar 105 upright in a vertical position within a guitar body cavity 120. The vertical guitar stand 100 includes a front 110 and rear 115 supports coupled to rods 125 and screws 130. The front 110 and rear 115 supports are spaced apart a desired width W to form the sides of the guitar body cavity 120. Two of the rods 125 are end rods 125a positioned near the ends of the cavity at a distance or length L, and two or more of the rods 125 are lower rods 125b positioned at the bottom of the cavity a height H.

The front 110 and rear 115 supports of the vertical guitar stand 100 include inner surfaces that are configured to frictionally engage the front and rear surfaces of a guitar body 106 with pressure or force. The amount of pressure or force F applied should be sufficient to allow the vertical guitar stand 100 to stay coupled with the guitar 105 when the guitar is lifted and moved moves from one place to another place, but also allow the guitar to be removed from the vertical guitar stand 100 when desired.

The front support and rear support may have the same shape or may have different shapes. For example, the rear support may be taller to support the back surface of the guitar and the front support may be shorter to avoid contacting the string mounts or electronics on the guitar front surface.

In some embodiments, the rods 125 and screws 130 may be a set or fixed length so that the width W is fixed between the front support 110 and the rear support 115. This may be desirable if the vertical guitar stand 100 cavity 120 is set up for one size guitar or is sold as a package with the guitar. In other embodiments, the rods 125 and screws 130 have an adjustable length, so that varying their length changes the cavity width W by moving the front support 110 closer to or further away from the rear support. One way of changing the width W to the desired width is to rotate the screw 130 in or out to increase or decrease their length. By rotating the screw 130 inwardly, the length of the rod gets shorter, bringing the front 110 and rear 115 supports closer together to a desired width W1. By rotating the screw outwardly, the length of the rods increases and distance between the front 110 and rear 115 support increases to a second desired width W2. This allows the vertical guitar stand 100 to work with multiple guitar widths.

In some embodiments, threaded inserts replace the bolts 130 used in the front support to couple with rods 125, so there are no bolts coming through the front support face. This eliminates the need for covering the bolt heads in the front. On the rear side the nuts may be cap nuts, thumb screw nuts for adjustability, or a combination of the two types of nuts. In this embodiment, after the guitar is positioned in the cavity, the threaded rods are adjusted to move the front and rear supports closer together to size the stand to the desired width W, then the excess rod extending through the inserts is cut off or broken off, for example, cut off with a pair of dykes.

The front 110 and rear 115 supports include inner surfaces that come into contact the guitar body when the guitar is positioned in the vertical guitar stand 100. To protect the guitar body from damage, such as scratches, The inner surface of the front 110 and rear 115 supports may include an anti-scratch material or treatment. In some embodiments, the front 110 and rear 115 supports are made of an anti-scratch material. In some embodiment, an anti-scratch treatment or covering is applied or attached to the inner surface, such as a fabric covering or plastic sheet.

In some embodiments, the vertical guitar stand 100 includes foam 135 coupled to the inner surfaces of the front support 110 and the rear support 115. When the front 110 and rear 115 supports are spaced at the desired width W, the foam is configured to engage the guitar body with a frictional fit to provide enough frictional pressure or force F to keep the guitar in the cavity 120. In some embodiments the foam is configured to compress during insertion of the guitar 105 into the vertical guitar stand 100, and expand back into shape after removal of the guitar. The compression of the foam is designed to apply a pressure or force on the guitar. The foam my also include a fabric covering 140 that directly touches the guitar body to protect it from scratches. The end rods 125a and lower rods 125b may also include a covering or sleeve to protect the guitar against scratches. In some embodiments, the vertical guitar stand 100 includes foam 135 coupled to the inner surfaces of the front support 110 and the rear support 115. When the front 110 and rear 115 supports are spaced at the desired width W, the foam is configured to engage the guitar body with a frictional fit to provide enough frictional pressure or force F to keep the guitar in the cavity 120. In some embodiments the foam is configured to compress during insertion of the guitar 105 into the vertical guitar stand 100, and expand back into shape after removal of the guitar. The compression of the foam is designed to apply a pressure or force on the guitar. The foam my also include a fabric covering 140 that directly touches the guitar body to protect it from scratches. The end rods 125a and lower rods 125b may also include a covering or sleeve to protect the guitar against scratches.

In some embodiments, the rods or posts 125 may include a ratcheting mechanism or ratcheting feature that is configured to hold the guitar between the front and rear supports. In use, the rods are in an extended position, with the cavity width W greater than the guitar width. Once the guitar is placed in the cavity, the ratcheting mechanism is used to pull the front and rear supports together and lock the guitar in the cavity. The ratchet mechanism may also include a release feature to unlock the ratchet so the guitar may be removed.

In some embodiments, the rods or posts 125 may include a spring mechanism that is configured to be stretched from a first position to a second position with a force increasing the distance or space between the front and rear supports, and once the guitar is put into the cavity 120, the force on the spring is released and the spring force moves the front and rear supports toward each other to clamp the guitar between them.

In some embodiments, the stand may be like a “chip-bag clip” having a flexible spring rotatably coupled with the front and rear supports so that the front and rear supports may be flexed outwardly so the guitar may be inserted into the cavity and then released so that the front and rear supports clamp down on the guitar.

In some embodiments, the vertical guitar stand 100 includes an inflatable bladder 135 coupled to the inner surfaces of the front support 110 and the rear support 115. The inflatable bladder 135 being configured to inflate and engage the guitar body with a frictional fit to hold the guitar 105 in the stand vertical guitar stand 100 and deflate to allow removal of the guitar 105. The inflatable bladder may also include an anti-scratch covering 140 that directly touches the guitar body to protect it from scratches. A small pump or other inflation means is used to inflate the foam bladder. The guitar stand 100 may include a sensor or other mechanism coupled to the bladder to sense when the guitar is between the front support 110 and a rear support 115 and inflate the bladder automatically.

In some embodiments, stabilizing feet, blades or tabs 150 may be used to add addition support to the stand if needed for stability. The feet 150 are attached to the front and rear supports and may include features to retract into a storage position when not needed. For example, the feet 150 may fit into notches on the bottom of the supports and attached with a screw for pivoting, such that they can swing out from a closed position, flush with the bottom, to an open position, at about 90 degrees. In another example, the feet may attach to a side of the supports and swing out from a close position to an open position.

The components of the vertical guitar stand 100 may use many different materials. The front support 110 and rear support 115 may be made of wood, plastic, or other suitable material. The rods 125 may be made of a metal or composite material. The screws may be standard screws. The foam may be any suitable foam, such as a soft density foam, that is capable of compressing and holding the guitar in the stand, and also able to go back to its original shape when the guitar is removed (memory foam). The foam may be ¼-inch and ½ inch thick or any desired thickness. The foam may be attached to the front and rear supports by known means, such as an adhesive. In some embodiments, the foam may be removably attached to using Velcro or snaps.

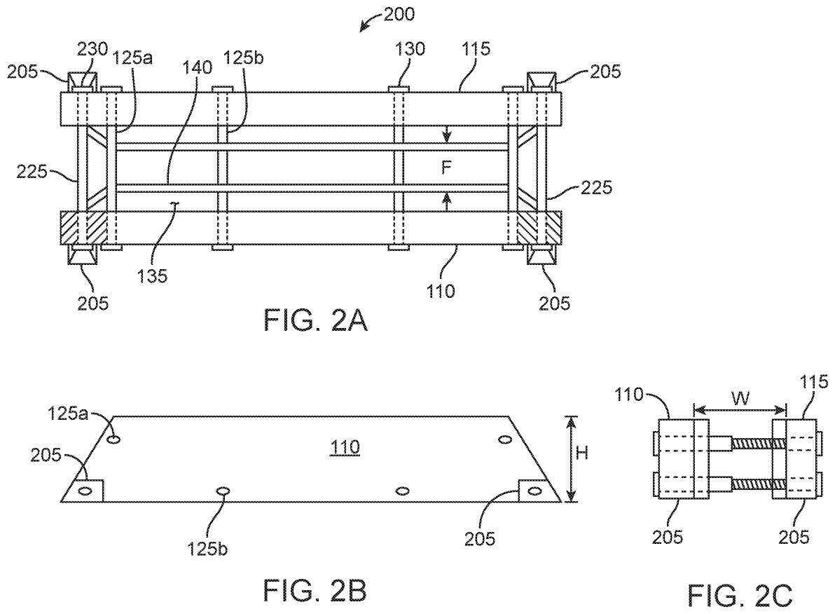

FIGS. 2A, 2B and 2C show one embodiment of a vertical guitar stand 200 is similar to vertical guitar stand 100 and also includes many of the same components, including a front support 110 and a rear support 115 that are spaced apart to form a guitar body cavity 120 having a width W. The front support 110 and the rear support 115 may be held together using a plurality of rods 125 and screws 130.

The vertical guitar stand 200 includes feet 205 coupled to the stand 200 that extend outwardly from the supports 110 and 115, forward and back, to provide additional stability. In the embodiment shown, the feet 205 are attached at existing bolt/rod locations, which may require using longer rods 225 or screws 230. In other embodiments, the feet 205 may use different mounting holes, or may be integrally formed with the front support 110 and/or rear support 115. There may be any number of feet or supports 205 as needed.

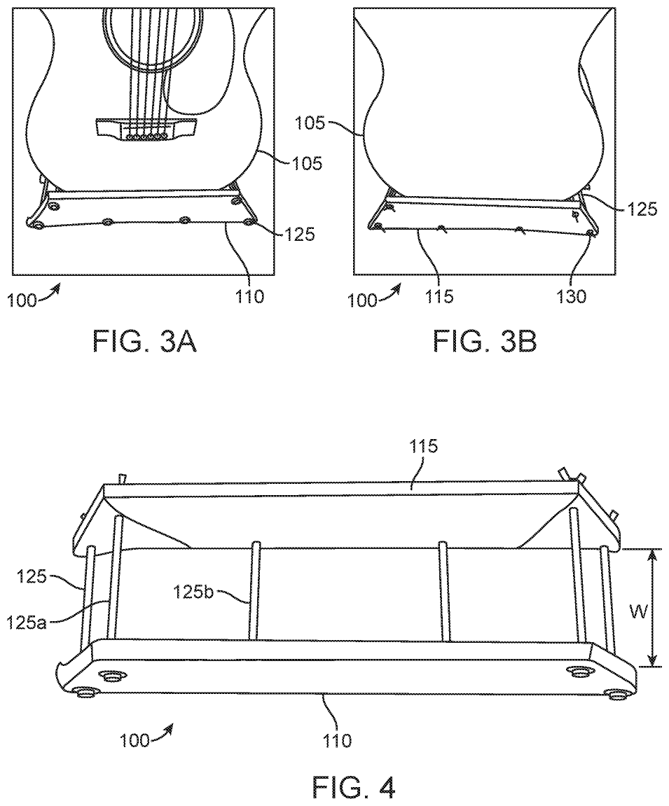

FIGS. 3A and 3B show front and rear views of an acoustic guitar 105 positioned within the vertical guitar stand 100. The vertical guitar stand 100 is designed to clamp to the guitar body with enough clamping pressure or force so that the vertical guitar stand 100 will remain attached to the guitar 105 as the guitar moves from one place to another place. The vertical guitar stand 100 may come in many different configurations to accommodate different size guitars bodies. The vertical guitar stand may also include adjustable embodiments so that the guitar stand will fit multiple guitar bodies.

FIG. 4 shows the vertical guitar stand 100 having a covering or fabric 140 covering the front support 110 and the rear support 115 to protect the surfaces of the guitar against scratches. The covering or fabric may be removable for cleaning or replacement.

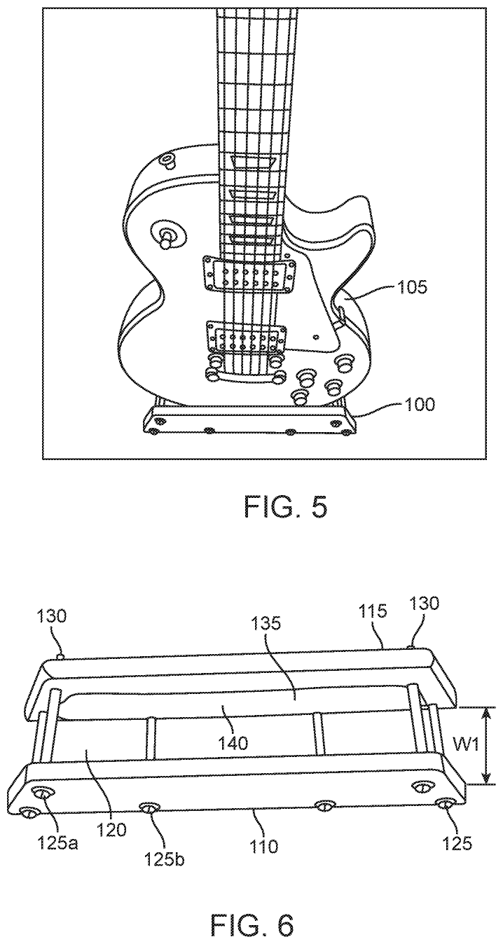

FIG. 5 shows a front view of an electric guitar 105 positioned within the vertical guitar stand 100. Typically the electric guitar and acoustic guitar 105 have different thicknesses, so the width W will be adjusted to W1 using one of the adjustment features. The vertical guitar stand 100 is designed to clamp to the guitar body with enough clamping pressure so that the vertical guitar stand will remain attached to the guitar as the guitar moves from one place to another place. The vertical guitar stand 100 may come in many different configurations to accommodate different size guitars bodies. The vertical guitar stand may also include adjustable embodiments so that the guitar stand will fit multiple guitar bodies.

FIG. 6 shows the vertical guitar stand 100 having a foam 135 with covering or fabric 140 attach the front support 110 and the rear support 115 to protect the surfaces of the guitar against scratches. The covering or fabric may be removable for cleaning or replacement. The foam provides a clamping pressure so that the stand will remain attached to the guitar such that if one moves the guitar from one place to another, the stand will move with the guitar. The front and rear supports are spaced apart and configured to engage the front and rear surface of a guitar with a slight clamping pressure.

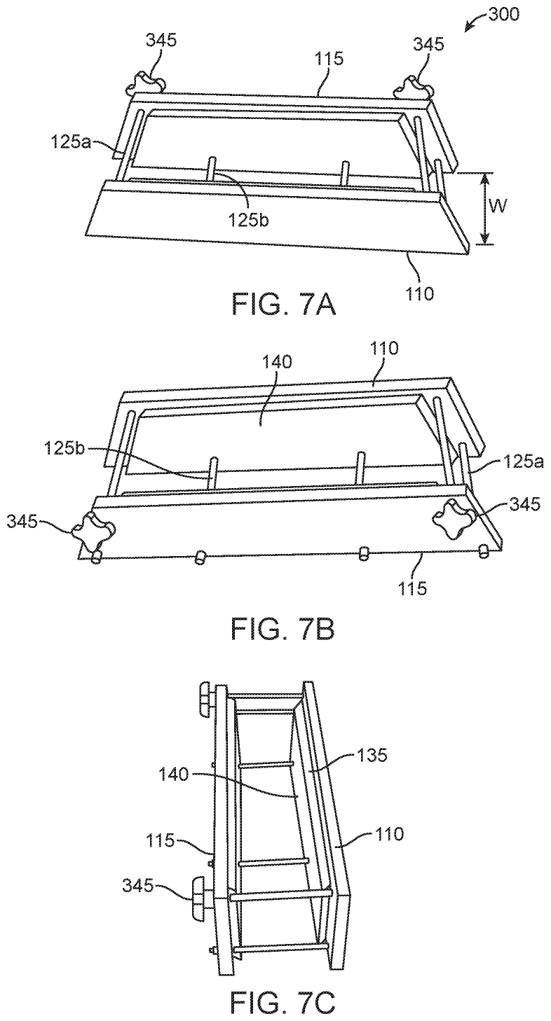

FIGS. 7A, 7B and 7C show front, rear and side views of another embodiment of a vertical guitar stand 300 that is similar to vertical guitar stand 100 and also includes many of the same components, including a front support 110 and a rear support 115 that are spaced apart to form a guitar body cavity 120 having a width W. The front support 110 and the rear support 115 may be held together using a plurality of rods or posts 125 and screws 130 with knobs 345. The vertical guitar stand 300 further includes a foam 135 with covering or fabric 140 attached to the front support 110 and the rear support 115 to protect the surfaces of the guitar against scratches.

In the embodiment shown, the distance between the front support 110 and the rear support 115 is adjustable to accommodate different guitar thicknesses. Some screws have an adjustable knob 145 to rotate and change the width W. By rotating the adjustable nut 145 inwardly, the length of the rods (130/125/145) gets shorter, bringing the front 110 and rear 115 support closer together a distance W1. By rotating the adjustable nut 145 outwardly, the length of the rods (130/125/145) increases, distance between the front 110 and rear 115 support increase to W2.

The vertical guitar stand has a low profile and does not take up much floor space. The vertical guitar stand may vary in size, depending on the instrument it is designed to hold. In one embodiment, the vertical guitar stand may have a width W of 1″-5″ wide, a length L of 9″ and a height H of 4″. The width W is selected to provide enough fiction and/or force to pick up and move the vertical guitar stand 100 and the guitar 105 together using one hand lifting the guitar neck. The can be helpful with moving the stand and guitar to the stage with other equipment. Also, the friction should not be too great to prevent removal of the guitar from the vertical guitar stand. Placing a foot on the vertical guitar stand 100 while pulling up vertically on the guitar 105.

In use, the guitar 105 is placed into the guitar body cavity 120 of the vertical guitar stand 100. The front and rear supports 110, 115 providing enough friction to hold the guitar in place. If the friction is not high enough, the width W may be adjusted to move the front and rear supports closer together for a tighter fit.

In one example, the guitar 105 is placed into the guitar body cavity 120 of the vertical guitar stand 100 and the foam 135 is then slightly compressed and the guitar is fully inserted. The foam providing enough friction to hold the guitar in place. If the friction is not high enough, the width may be adjusted for a tighter fit by turning the adjustable nuts or screws to move the front and rear supports closer together.

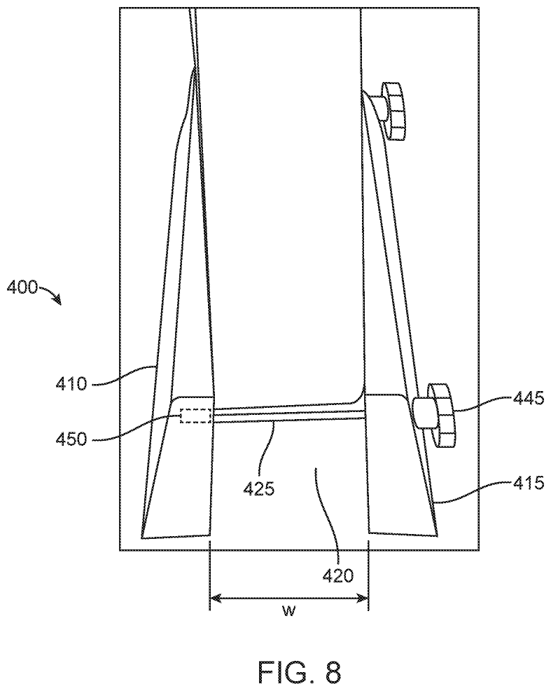

FIG. 8 shows another embodiment of a vertical guitar stand 400 that is designed to hold a guitar 105 upright in a vertical position within a guitar body cavity 420. The vertical guitar stand 400 includes a front 410 and rear 415 supports coupled to rods 425 and knobs 445. The rods are threaded and couple with threaded inserts 450 in the front support 410. The front 410 and rear 415 supports are spaced apart a desired width W to form the sides of a guitar body cavity 420. The front 410 and rear 415 supports have a shape in which a lower surface or base is wider than an upper surface, such as a pedestal shape or a right trapezoid. Two of the rods 425 are positioned near the ends of the cavity at a distance or length L, and two or more of the rods 425 are positioned at the bottom of the cavity a height H.

In some embodiments, the vertical guitar stand 400 includes foam 135 coupled to the inner surfaces of the front support 410 and the rear support 415. When the front 410 and rear 415 supports are spaced at the desired width W, the foam is configured to engage the guitar body with a frictional fit to provide enough friction to keep the guitar in the cavity 420. The foam may be able to compress during insertion of the guitar and expand back into shape after removal of the guitar. The foam my also include a fabric covering 140 that directly touches the guitar body to protect it from scratches. The end rods and lower rods may also include a covering or sleeve to protect the guitar against scratches.

In some embodiments, the width W may be fixed between the front support 410 and the rear support 415 for one size guitar or is sold as a package with the guitar, or may be adjustable to vary the cavity width W by moving the front support 410 closer to or further away from the rear support 415. One way of changing the width W to the desired width is to rotate the knob 445 in or out to increase or decrease their length. By rotating the knob 445 inwardly, the length of the rod gets shorter, bringing the front 410 and rear 415 supports closer together to a desired width W1. By rotating the knob 445 outwardly, the length of the rods increases and distance between the front 410 and rear 415 support increases to a second desired width W2. This allows the vertical guitar stand 400 to work with multiple guitar widths.

The components of the vertical guitar stand 400 may use many different materials. The front support 410 and rear support 4115 may be made of wood, plastic, or other suitable material. The rods 425 may be made of a metal or composite material. The foam may be any suitable foam, such as a soft density foam, that is capable of compressing and holding the guitar in the stand, and also able to go back to its original shape when the guitar is removed (memory foam). The foam may be ¼-inch and ½ inch thick or any desired thickness. The foam may be attached to the front and rear supports by known means, such as an adhesive. In some embodiments, the foam may be removably attached to using Velcro or snaps.

In some embodiments, the vertical guitar stand 400 includes an inflatable bladder that is configured to inflate to hold the guitar in the stand vertical guitar stand 400 and deflate to allow removal of the guitar. A small pump or other inflation means is used to inflate the foam bladder. The guitar stand 400 may include a sensor or other mechanism coupled to the bladder to sense when the guitar is between the front support 410 and a rear support 415 and inflate the bladder automatically.

Various modifications to the implementations described in this disclosure may be readily apparent to those skilled in the art, and the generic principles defined herein may be applied to other implementations without departing from the spirit or scope of this disclosure. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure. Thus, the disclosure is not intended to be limited to the implementations shown herein, but is to be accorded the widest scope consistent with the principles and features disclosed herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

What is claimed is:

1. A vertical guitar stand comprising:
a front support coupled to a rear support to form the sides of a guitar body cavity having a width W between the front and rear supports; and
wherein the width W is the thickness of a guitar body that provides a frictional fit with a guitar body when the guitar is inserted in the cavity.

2. The vertical guitar stand of claim 1, further comprising a plurality of rods coupled with the front and rear supports.

3. The vertical guitar stand of claim 2, wherein varying a length of the rods changes the width W of the guitar body cavity.

4. The vertical guitar stand of claim 2, wherein the rods include a ratcheting mechanism or ratcheting feature.

5. The vertical guitar stand of claim 2, wherein the rods include a spring mechanism that is configured to be stretched from a first position to a second position with a force increasing the distance or space between the front and rear supports, and once the guitar is put into the guitar body cavity the force on the spring clamps the guitar between the front and rear supports.

6. The vertical guitar stand of claim 2, wherein the rods include a flexible spring coupled with the front and rear supports so that the front and rear supports may be flexed outwardly so the guitar may be inserted into the guitar body cavity and the flexible spring provides pressure of force to clamp the guitar between the front and rear supports.

7. The vertical guitar stand of claim 1, further comprising foam coupled to the front and rear supports, the foam being configured to compress during insertion of the guitar into the vertical guitar body cavity and expand back into shape after removal of the guitar from the guitar body cavity.

8. The vertical guitar stand of claim 1, further comprising inflatable bladders coupled to the front and rear supports, the inflatable bladders being configured to inflate and engage the guitar body with a frictional fit to hold the guitar in the stand vertical guitar stand and deflate to allow removal of the guitar.

9. The vertical guitar stand of claim 1, further comprising an anti-scratch material or anti-scratch treatment coupled to an inner surface of the front and rear supports.

10. The vertical guitar stand of claim 9, wherein the anti-scratch material or anti-scratch treatment includes a fabric covering coupled to the inner surfaces.

11. The vertical guitar stand of claim 1, further comprising stabilizing features coupled to the front and rear supports for stand stability.

12. A vertical guitar stand comprising:
a front support having an inner surface configured to frictionally engage a guitar body;
a rear support having an inner surface configured to frictionally engage a guitar body; and
a plurality of rods coupled with the front and rear supports to form a guitar body cavity having a width W between the front and rear supports;
wherein the inner surfaces of the front and rear supports form the sides of the guitar body cavity and frictionally engage the guitar body with sufficient pressure or force to retain the vertical guitar stand when the guitar is lifted.

13. The vertical guitar stand of claim 12, wherein varying a length of the rods changes the width W of the guitar body cavity.

14. The vertical guitar stand of claim 12, further comprising foam coupled to the inner surfaces of the front and rear supports, the foam being configured to compress during insertion of the guitar into the vertical guitar body cavity and expand back into shape after removal of the guitar from the guitar body cavity.

15. The vertical guitar stand of claim 12, further comprising inflatable bladders coupled to the front and rear supports, the inflatable bladders being configured to inflate and engage the guitar body with a frictional fit to hold the guitar in the stand vertical guitar stand and deflate to allow removal of the guitar.

16. The vertical guitar stand of claim 12, further comprising an anti-scratch material or treatment coupled to the inner surfaces of the front and rear supports.

17. The vertical guitar stand of claim 12, further comprising stabilizing features coupled to the front and rear supports for stand stability.

18. A method of using a vertical guitar stand comprising:
providing vertical guitar stand comprising a front support coupled to a rear support to form the sides of a guitar body cavity having a width W between the front and rear supports; the front and rear supports configured to provides a frictional fit with a guitar body
inserting a guitar into the guitar body cavity; and
frictionally engaging the guitar body with sufficient pressure or force to retain the vertical guitar stand to the guitar when lifted.

19. The method of claim 18, further comprising varying the width W to accommodate the thickness of the guitar body.

20. The method of claim 18, further comprising removing the from the vertical guitar stand.
